(19) United States
(12) Patent Application Publication
(10) Pub. No.: US 2005/0152401 A1
(43) Pub. Date: Jul. 14, 2005

(54) Arranging packet-switched data transmission in wireless system

(76) Inventors: Juha Wiljakka, Riitiala (FI); Janne Rinne, Tampere (FI); Jarkko Jouppi, Seinajoki (FI)

Correspondence Address: PERMAN & GREEN, 425 POST ROAD, FAIRFIELD, CT, 06824, US

(21) Appl. No.: 11/007,109

(22) Filed: Dec. 8, 2004

(30) Foreign Application Priority Data
Dec. 19, 2003 (FI) 20031877

(51) Int. Cl. H04Q 7/24

(52) U.S. Cl. 370/474

(57) ABSTRACT

The invention relates to a method for arranging packet-switched data transmission in a wireless system. The method activates a packet data transmission context between a mobile station and a network element providing wireless packet-switched data transmission, a first address being attached to the transmission context. In addition to the first address, a second address is attached to the transmission context. The packets, whose IP address field includes the second address or just the first address, are transmitted using the established transmission context.

### FIELD OF THE INVENTION

The invention relates to arranging data transmission in a wireless system providing packet-switched data transmission and in particular to selecting a transmission context.

### BACKGROUND OF THE INVENTION

GPRS-based packet-switched services relating to GPRS (General Packet Radio Service) services, developed for the second generation GSM networks, and to the third generation 3GPP (Third Generation Partnership Project) employ PDP (Packet Data Protocol) contexts for the transmission of user data.

In the 3GPP system a mobile station can be provided with one or more PDP contexts, each having a different quality of service profile. In accordance with the quality of service profile negotiated during PDP context establishment, a radio access bearer service is reserved to provide the mobile station with service best suited to the negotiated quality of service profile. A PDP address identifies the mobile station to which the PDP context belongs. The same PDP address can be used by a plurality of PDP contexts (the primary PDP context and one or more secondary PDP contexts). The PDP context is linked to an access point name (APN), which is a logical name, refers to a GGSN node and identifies the access point to external networks. More information about the basic functions of the GPRS system can be found in the 3GPP specification, 3GPP TS 23.060, version 6.2.0., September 2003.

As it can be seen in the above-mentioned 3GPP specification, the 3GPP systems have different PDP types for IPv4 and IPv6 traffics. Hence, it is necessary to activate separate PDP contexts for IPv4 services and IPv6 services. However, there is a problem that typically the user does not know whether he/she is using IPv4- or IPv6-based services, and consequently he/she is not necessarily able to select a suitable access point name APN and a PDP context type for IPv4 or IPv6 traffic. For instance, if the user activates a PDP context associated with an access point name APN conveying IPv4 traffic it may not be possible to open IPv6 pages at all, and the user is only given an error message. In order to enable the user to browse also these pages, he/she should close the browser and change the PDP context properties or activate a new PDP context of IPv6 type to an access point name conveying IPv6 traffic, and thereafter re-establish a connection to the IPv6 page. This is inconvenient for the user, however, and many users are not able to perform such operations, because they cannot distinguish between the IPv4 pages and the IPv6 pages. There are various protocol translators performing protocol conversions from IPv4 into IPv6, but they are not implemented in all networks, however. The use of protocol translators also causes certain problems: they do not enable actual end-to-end IP protocol use, and in case of failure in the translator, communication will not be possible. Another alternative is to activate separate PDP contexts for IPv4 traffic and IPv6 traffic, but this is not efficient use of resources in the terminal.

For the implementation of a GGSN node there is developed a so-called dual stack solution, in which both IPv4 traffic and IPv6 traffic could be conveyed through an access point name. This does not eliminate the above-mentioned problem, however, because it will still be necessary to activate separate PDP contexts for IPv4 traffic and IPv6 traffic, which contexts are nevertheless associated with the same access point name in the GGSN node.

### BRIEF DESCRIPTION OF THE INVENTION

It is the object of the invention to provide a method and means for implementing the method such that the above-mentioned problems can be avoided or that they can be at least reduced. This is achieved by a method, a telecommunications system, a mobile station and a network element, which are characterized by what is stated in the independent claims. Some preferred embodiments of the invention are disclosed in the dependent claims.

The invention is based on the idea that, in addition to a first address, a second address is included in a transmission context between a mobile station and a network element. Thus the packets whose IP address is the second address or the first address are transferred using the established transmission context. In general the transmission context refers to a logical data flow with specific properties between a mobile network and a mobile station, for instance to a PDP context having negotiated quality of service parameters.

The arrangement according to the invention has an advantage that data of at least two different address types, for instance IPv4- and IPv6-type data, can be conveyed by the same transmission context. In that case the user need not know the type of traffic transferred, nor be able to select a correct transmission context type, and consequently the user-friendliness of packet-switched services improves considerably. When a need arises to transfer packets of different address types, it is possible to reduce the number of transmission contexts, whereby less resources are needed in the mobile station and the network element for arranging the packets to be transferred.

In accordance with one embodiment address allocation is arranged such that the second address is part of the first address. Between the network element and the mobile station there is a need to transmit only the first address, from which the second address can be derived. This embodiment does not necessitate changes, for instance, in the signalling messages of the PDP contexts of the current GPRS specifications, in which only one address is defined.

### BRIEF DESCRIPTION OF THE DRAWINGS

In the following the invention will be described in greater detail in connection with preferred embodiments, with reference to the attached drawings, in which

FIG. 1 illustrates a UMTS system in general;

FIG. 2 shows UMTS user level protocol architecture;

FIGS. 3a and 3b are flow charts of methods according to an embodiment;

FIG. 4 is a signalling chart of activating a PDP context in accordance with an embodiment; and

FIG. 5 shows an IPv6 address format.

### DETAILED DESCRIPTION OF THE INVENTION

A procedure according to a preferred embodiment of the invention will be described below by way of example in connection with a 3GPP system. However, the invention can be applied to any packet-switched, wireless data communications system, in which there is a need to transfer data using different address types. The procedure of the invention can be applied, for instance, to packet-data transmission service operating over a second generation access network, for instance, to a GPRS service operating over a base station subsystem (BSS) according to the GSM specifications or to other third generation systems.

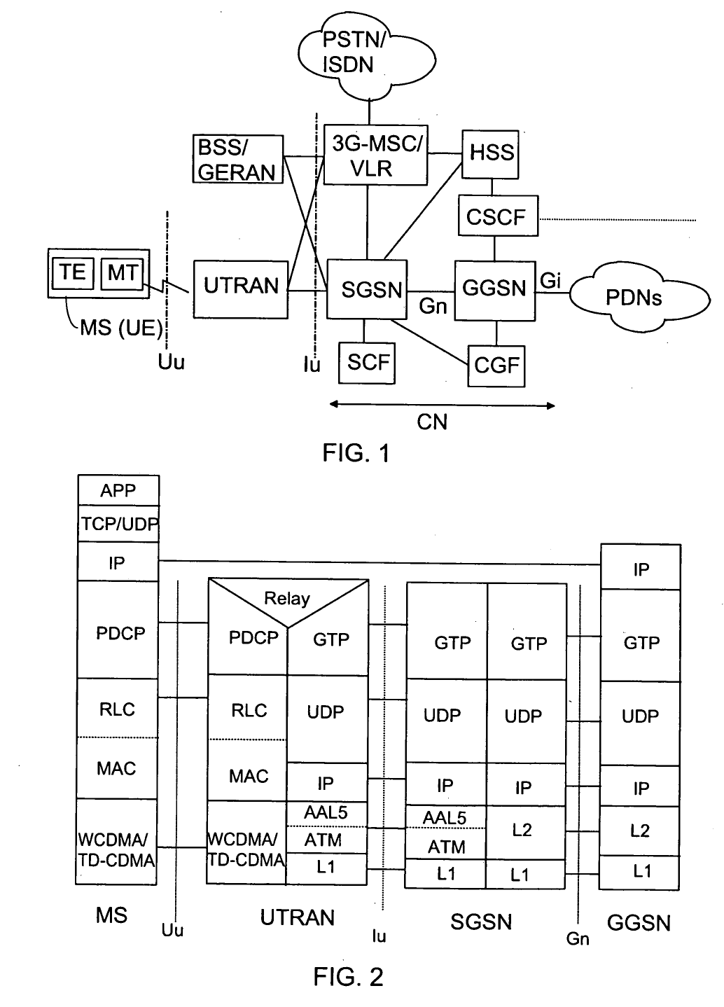

Reference is made to FIG. 1, where the main parts of a mobile system include a core network CN and a UMTS terrestrial radio access network UTRAN, which constitute a fixed network of the mobile system, and a mobile station MS, which is also called a user equipment UE. The interface between CN and UTRAN is called lu, and the interface between UTRAN and MS is called Uu.

Typically UTRAN consists of a plurality of radio network subsystems RNS, and the interface between them is called Iur (not shown). RNS consists of a radio network controller RNC and one or more base stations BS, which are also referred to as node B. The interface between RNC and BS is called Iub. The base station BS implements a radio path and the radio network controller RNC manages radio resources. The UMTS core network CN can also be accessed via the GSM base station subsystem BSS or the GSM/EDGE (Enhanced Data rates for GSM Evolution) radio access network GERAN.

The core network CN consists of extra-UTRAN infrastructure belonging to the mobile system. In the core network a mobile switching centre/visitor location register 3G-MSCNLR takes care of circuit-switched calls and communicates with a home subscriber server HSS. A connection to a serving GPRS support node SGSN is established through an interface Gs′ and to the fixed telephone network PSTN/ISDN through a gateway mobile switching centre GMSC (not shown). The connections of 3G-MSCNLR and SGSN to the radio network UTRAN take place through the interface lu.

Thus, the 3GPP system also comprises a: packet radio system that is largely implemented in accordance with the GPRS system connected to the GSM network, and therefore the network element names bear references to the GPRS system. The UMTS packet radio system may comprise a plurality of gateway and serving GPRS support nodes and, typically, a plurality of serving GPRS support nodes SGSN are connected to one gateway GPRS support node. The function of SGSN is to detect mobile stations capable of packet radio connections in its service area, to transmit data packets to and receive them from said mobile stations as well as to monitor the location of the mobile stations within its service area. Further, SGSN communicates with the home subscriber server HSS via the interface Gr. The home subscriber server HSS also stores packet-radio-service-related files, which comprise the contents of subscriber-specific packet data protocols. HSS comprises, for instance, data on PDP contexts allowed to the subscriber and data for utilizing the services provided by IMS.

The gateway node GGSN serves as a gateway between the packet radio system of the UMTS network and an external packet data network PDN. External data networks may include, for instance, a UMTS network or a GPRS network of another operator, the Internet, or a private local area network. The gateway node GGSN communicates with said data networks via the interface Gi. The data packets transferred between GGSN and SGSN are always encapsulated in accordance with the tunnelling protocol GTP (Gateway Tunnelling Protocol). GGSN also maintains PDP addresses of the PDP contexts activated for the mobile stations and routing data, i.e. SGSN addresses and NSAPI (Network layer Service Access Point Identifier) identifiers. The routing data are thus used for linking data packets between an external data network and SGSN. The network between GGSN and SGSN is a network utilizing IP connection procedure. The packet data system may also comprise many other functions, of which FIG. 2 shows a control function SCF of intelligent network services, preferably CAMEL services, a charging gateway function CGF and a call session control function CSCF of IMS system (IP Multimedia Subsystem).

The -3GPP packet data protocol architecture is divided into a user plane and a control plane. The control plane includes 3GPP-specific signalling protocols. FIG. 2 illustrates the user plane, which delivers user data in protocol data units PDU between the mobile station and GGSN. At the interface Uu between the radio network UTRAN and the mobile station MS, lower-plane data transfer on a physical layer Li takes place in accordance with the WCDMA or TD-CDMA protocol. The MAC layer on top of the physical layer conveys data packets between the physical layer and the RLC (Radio Link Control) layer, and the RLC layer is responsible for radio link management of different logical connections. The RLC functions include, for instance, segmentation of transmitted data into one or more RLC data packets. PDCP (Packet Data Control Protocol) adapts the needs of upper layers for radio interface protocols below and takes care of the transmission of PDCP data units over a radio sub-network and takes care of the compression and decompression of header fields of IP data flows. PDCP, RLC and MAC constitute a transmission link layer. SGSN is responsible for routing of data packets-received from the mobile station MS via the radio network RAN further to a correct gateway node GGSN. This connection employs a tunnelling protocol GTP, which encapsulates and tunnels all user data and signalling conveyed via the core network. The GTP protocol is run on the IP protocol used by the core network. The IP protocol is used in the UMTS network for two different purposes. The upper IP layer is a so-called application layer IP, which is used between MS and GGSN and for a peer in an external IP network. On top of the upper IP layer it is possible to execute a TCP or UDP protocol, which the applications APP utilize. It should be noted that the applications APP and the upper IP stack may be located in separate terminal equipment TE, whereby a separate mobile terminal MT serves as a device communicating with the UMTS network. A combination of a portable computer and a UMTS card phone is an example of this kind of wireless terminal equipment.

In order to obtain packet-switched services the mobile station MS should perform an attach procedure, in which the location of MS is made known in SGSN. Thereafter MS can receive short messages and calls from SGSN. In order to receive and transmit packet-switched data MS must activate at least one PDP context, which makes MS known in GGSN and establishes a logical data transmission context in MS, SGSN and GGSN. While the PDP context is established, there is determined for MS a PDP address that can be an IPv4 address, an IPv6 address or in accordance with an embodiment of the present invention an IPv6 address including an IPv4 address. In addition to other PDP context data, such as the negotiated QoS profile, the PDP address is determined to be included in context information maintained by GGSN.

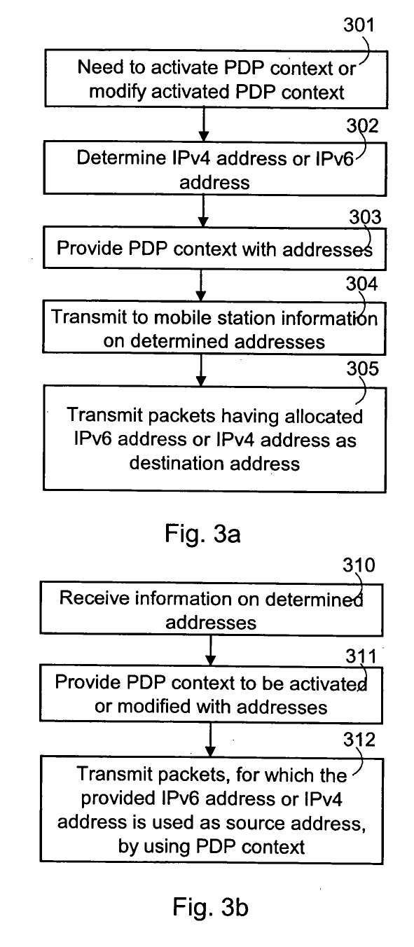

The mobile station MS comprises memory, a user interface, a transceiver for wireless data transmission, and a central processing unit including one or more processors. Various applications can be implemented in MS by executing the computer program code stored in the central processing unit. By means of a computer program code to be executed in the central processing unit and/or hardware solutions it is also possible to make the mobile station MS implement tasks determined for protocols illustrated in FIG. 2. In addition, the computer program codes to be executed in the central processing unit and/or the hardware solutions permit the mobile station MS to implement the inventive functions relating to the attachment of the transmission context and addresses of various types and to the arrangement of packet transmission, embodiments of which are illustrated in connection with FIGS. 3, 4 and 5. The network element, such as GGSN, also comprises a processing unit, and by means of a computer program code executed therein it can be arranged to implement functions described in the following. In the network element, it is also possible to use hardware solutions or a combination of software and hardware solutions.

FIGS. 3a and 3b illustrate a method according to one embodiment. FIG. 3a illustrates a method that can be applied in a device allocating addresses, in accordance with one embodiment, in GGSN. In step 301, there is a need to activate a PDP context or to modify the activated PDP context. The mobile station MS or the network may have initiated that, for instance, in response to a received packet (network initiated PDP context activation).

In step 302, an IPv4 address and an IPv6 address are determined in accordance with the present embodiment such that the IPv6 address includes the IPv4 address. The PDP context to be activated or modified is provided 303 with both addresses. In step 303 it is possible to store both addresses in the PDP context information. A PDP context of this kind supporting both IPv4 and IPv6 traffic can be formed in response to information received from the mobile station MS, in accordance to which it also supports the use of both addresses in the PDP context. MS can be arranged to transmit this data or a special request for using both addresses as a new parameter in the PDP activation request, for instance. The PDP context applying both addresses can also be activated, however, without information from the mobile station MS. In accordance with one embodiment an IPv4 address can always be determined for PDP contexts of IPv6 type, because the mobile stations not supporting the present method are simply not able to pick up the IPv4 address from the IPv6 address, but they operate in the known manner and thus transmit and receive only data in IPv6 format using the PDP context.

In step 304, information on the determined addresses is transmitted to the mobile station MS, at least the IPv6 address from which the IPv4 address can be deduced. After having activated or modified the PDP context, in step 305 it is possible to transmit packets having the determined IPv6 address or just the IPv4 address as the destination address by using the PDP context. The device applying the method of FIG. 3a is thus arranged to compare the IPv4 destination addresses of the received packets with the IPv4 addresses included in the activated PDP contexts, and correspondingly, the IPv6 destination addresses with the IPv6 addresses and to transmit the packets to SGSN using the data of the PDP context to which the destination address is included. It is also possible that the device is arranged to compare the destination addresses with all addresses attached to the PDP contexts irrespective of the IP address type.

FIG. 3b illustrates a method that can be applied to a device receiving the addresses, in accordance with one embodiment, a mobile station MS. An IPv6 address that also includes an IPv4 address is received in step 310. This-step is proceeded to when a message relating to activating or modifying the PDP context is received from the network. Thus, MS is arranged to determine an IPv4 address from a predetermined area in the IPv6 address and to add 311 it, in addition to the IPv6 address, to the PDP context to be activated or modified, for instance in PDP context information or in IP-layer determinations. When the addresses and other optional PDP context data have been stored in the PDP context data, in step 312 MS is arranged to transmit packets received from the upper protocol layer and having the allocated IPv6 address or just the IPv4 address as the source IP address by using the PDP context. After the addresses have been received, the IP layer is arranged to add to packets associated with said addresses, received from the application layer, the IP address of a correspondent node indicated by the application to serve as the destination IP address, and either the allocated IPv4 address or the IPv6 address to serve as the source IP address. The mobile station MS is arranged to check the address in the source IP address field and to define in which PDP context it is included.

Because the IPv4 address and the IPv6 address including said IPv4 address can be determined in the PDP context information, according to one embodiment in step 312 MS is arranged to determine first the type of the source address of the packet and then to compare it only with the addresses of the same type in the PDP information. MS is arranged to compare the IPv6-format source address of the packet with the IPv6 addresses determined in the PDP context information and to use for packet transfer the PDP context including said IPv6 address. If the transmitted packet has a 32-bit, source address in IPv4 format, MS is arranged to compare it with the addresses in IPv4 format in the context data and to use the PDP context including the same address as the one in the source address field of the packet. Alternatively, the mobile station MS can be arranged to compare the address in the source address field with all IPv4 and IPv6 addresses determined in the context information and to select the PDP context including the same address.

According to another embodiment there is a direct binding between the PDP context and the IPv4 and IPv6 addresses on the IP layer already, so no separate checking of a source IP address field is needed. In that case the IP layer sees the PDP context as one network interface and is arranged to convey packets, whose source IP address is determined to be the IPv4 address or the IPv6 address that is added to said PDP context in step 311.

Unlike the features illustrated above, in accordance with one embodiment the mobile station MS allocates an IPv6 address including an IPv4 address and transmits it to GGSN in a PDP context activation or modification request in a space reserved for a PDP address. MS may also indicate in the request, or according to another embodiment, in the IPv6 address that the IPv6 address also includes the IPv4 address that is to be used in data transmission. GGSN can include the addresses suggested by MS directly to the PDP context or, for instance, if the prefix is not unique, to allocate a new IPv6 address that may also include an IPv4 address. If GGSN does not support the use of both addresses in the PDP context, MS detects this in a PDP context response message. In that case MS can be arranged to activate a second PDP context for IPv4 traffic or to transmit only packets in IPv6 format.

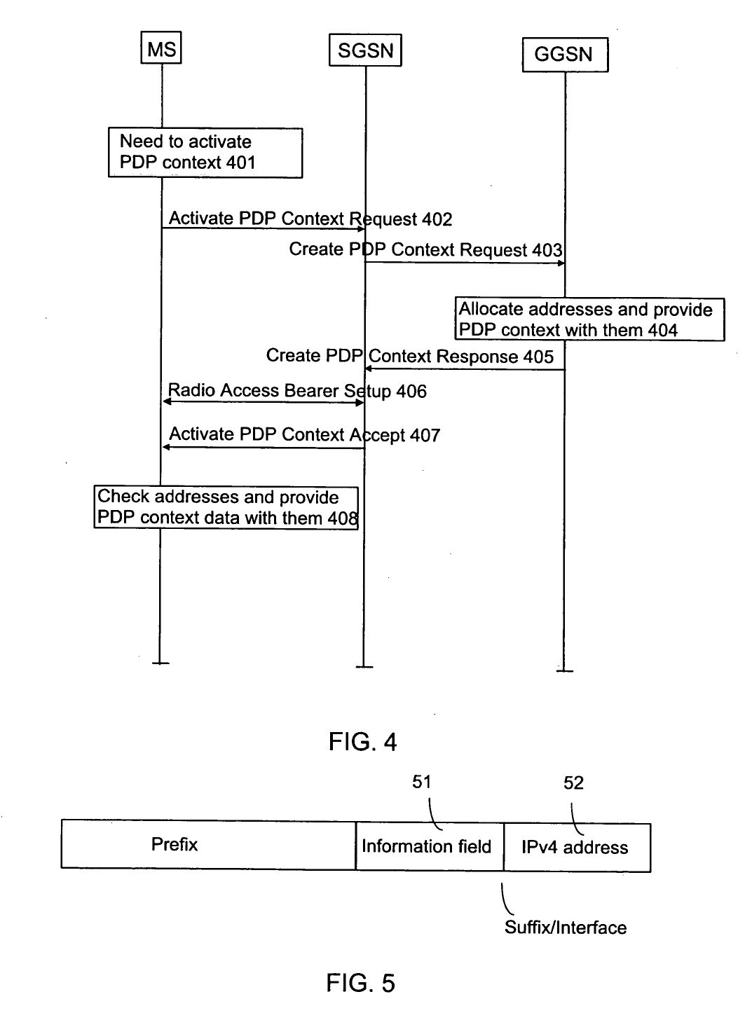

FIG. 4 illustrates PDP context activation in accordance with one embodiment, in which the PDP context is provided with IPv4 and IPv6 addresses allocated in GGSN. A need 401 to activate the PDP context may arise, for instance, from a session initiation request of the mobile station or the other party of the logical connection to be established on the application plane. In that case an entity implementing GPRS service, in this example SGSN, receives a request for PDP context establishment. The request may define that there is a need to activate a PDP context suitable for both IPv4 and IPv6 traffic. The mobile station MS adapts the quality of service requirements of the application plane (or IP plane) to the GPRS quality of service, i.e. it determines the QoS parameters to be requested for the PDP context. On activating the PDP context the mobile station MS transmits 402 for GGSN a request (Activate PDP Context Request). The request may be in accordance with the present specifications, or it may indicate whether MS supports IPv4 and IPv6 traffic and/or a PDP context supporting IPv4 and IPv6 traffic is to be activated.

After step 402 it is possible to perform security functions between MS and SGSN. Typically, on the basis of subscriber data and/or request 402 SGSN determines an access point name and a gateway GPRS support node to be used and transmits 403 to GGSN a request to create a PDP context.

GGSN receives the request and allocates 404 an IPv6 address including an IPv4 address and creates a new entry in the PDP context information. Already known data can be determined in the PDP context data, with the exception that there are two addresses as the PDP address. As regards other PDP context data, reference is made to Chapter 13.3 of said 3GPP Specification 23.060. The PDP context having been defined in GGSN it may transfer packets having the allocated IPv6 address or just the IPv4 address as the destination address, in the manner illustrated in connection with step 305, using the data of this PDP context.

GGSN transmits a response 405 (Create PDP Context Response) to SGSN. SGSN can start setting up a radio network service, whereby a radio access bearer setup is provided 406 for MS. SGSN updates data it maintains relating to the PDP context, in particular attaches both the IPv4 address and the IPv6 address to the PDP context. As regards other PDP context data maintained by SGSN, reference is made to Chapter 13.2 of the 3GPP Specification 3GPP TS 23.060 V6.2.0. “General Packet Radio Service (GPRS); Service Description; Stage 2; Release 6”, September 2003. SGSN responds 407 (Activate PDP Context Accept) to the mobile station MS. The mobile station MS checks 408 the message for the IPv4 and IPv6 addresses, for instance, and updates its context data with a new PDP context. The IPv4 and IPv6 addresses are thus determined as the PDP address. As regards other PDP context data maintained by the mobile station MS, reference is made to Chapter 13.4 of the above-mentioned 3GPP Specification 23.060. As described in connection with step 312, MS may now transmit the determined IPv6 address or just the IPv4 address as the source IP address, and correspondingly receive data packets with the determined IPv6 address or just the IPv4 address as the destination IP address by using the activated PDP context. After step 407/408 the MS application or an entity allocating quality of service thereto may still transmit necessary messages end to end for the final activation of a session. As regards a more detailed description of other functions relating to activation, modification or deactivation of the PDP context, reference is made to Chapter 9 of the above-mentioned 3GPP Specification 23.060. It should be noted that more than one address can also be applied to a secondary PDP context and the addresses can be used in more than one PDP context.

Alternatively, unlike in what is stated in connection with FIGS. 3 and 4, according to one embodiment providing the PDP context with the IPv4 and IPv6 addresses is arranged in the mobile station MS and/or in the network element GGSN such that only the IPv6 address is stored in the PDP context data. And, the mobile station MS and the network element GGSN are arranged to determine the IPv4 portion from the IPv6 address when defining a PDP context to be used for a transmitted packet. MS and GGSN are arranged to compare the IPv4 addresses obtained from the IPv6 addresses determined in the PDP context data with the IPv4-format address of the packet to be transmitted, in particular with the source address in the mobile station MS and with the destination address in GGSN. The packets are then transmitted using the PDP context whose IPv4 address, determined from the IPv6 address in the PDP information, matches with the source/destination address. This embodiment has an advantage that the PDP context information need not be changed, because only one address in IPv6 format is stored therein.

FIG. 5 illustrates a PDP address format according to one embodiment for use in the address of the present PDP context. A prefix consisting of the first 64 bits is in accordance with the IPv6 definitions and globally unique in accordance with the 3GPP requirements, and thus GGSN can distinguish between the PDP contexts on the basis thereof. A suffix consisting of the latter 64 bits includes at least an IPv4 address 52, which in this case occupies the last 32 bits.

In accordance with one embodiment, the first 32 bits of the suffix constitute an information field 51, in which it is possible to convey, from the gateway node GGSN to the mobile station MS, data necessary for connection setup. For instance, in the information field it is possible to indicate whether both of the address types are available in GGSN. This can be indicated using one bit, for instance, such that if the first suffix bit is 0, the IPv4 address is not allocated, or if the first bit is 1, the last 32 suffix bits determine the IPv4-format address of the PDP context. Also other information relating to addressing and/or PDP context can be conveyed by means of these bits. Transfer of a second IPv4-format address and address of a DNS (Domain Name System) server in IPv4 format are some examples of this embodiment. This embodiment has an advantage that additional information can be transferred between GGSN and MS without having to determine the messages conveying this information in the standards.

According to one embodiment an access point name APN referring to a resource of GGSN is arranged such that it will refer to the gateway node GGSN and the resource thereof, through which it is possible to transfer data provided with IPv4 and- IPv6 addresses. In that case just one APN is needed, to which the above-illustrated PDP context utilizing two addresses will be linked in GGSN. When there is a need to transfer data in IPv4 and IPv6 formats, MS can be arranged to request an access point name APN of this kind in a PDP context activation request 402. It is also possible that, on the basis of the request by MS, SGSN is arranged to select an access point name APN that supports transfer of data in IPv4 and IPv6 formats.

For instance, the Symbian operating system allows (intra-device) storing of logical Internet access points (IAP), where a plurality of earlier illustrated connection setup parameters, such as PDP type and access point name APN, are determined. When the present method is applied to these logical Internet access points, it is possible to determine one or more Internet access points by which IPv4 and IPv6 traffic can be conveyed. When an access point of this type is selected for packet-switched service, a connection can be automatically established from MS to GGSN, with which there is formed a PDP context bound to an IPv4 address and an IPv6 address including said IPv4 address. An access point of this kind can serve, for instance, as a default access point, and thus the user need not pay attention to address types and various web sites should load successfully.

The present solution is fully compatible with previous PDP types in use, because mobile stations that comply with the specifications used until now and activate a PDP context of IPv6-type will still obtain a valid IPv6 address but they just do not detect that the prefix also includes an IPv4 address, so they use only the IPv6 address with the activated PDP context. On the other hand, mobile stations of the present embodiment that try to obtain both an IPv4 address and an IPv6 address for the PDP context, will detect from the first suffix bits, for instance, that the GGSN does not support this feature, whereafter they can use only the IPv6-format address in connection with the PDP context.

Other embodiments that differ at least in part from the above-described embodiment will be described briefly in the following. The system may also introduce a completely new PDP type, for instance “v4v6”, which defines that both IPv4 traffic and IPv6 traffic can be transferred by using said PDP context. In order for this PDP context to be activated, both MS and GGSN must support the use of this new PDP context type. Another alternative is to leave PDP type determination out of the PDP context activation, whereby the PDP context is not linked to any particular IP address type, but the above-illustrated IPv6 addresses including an IPv4 address can be used in one PDP context of this type. In accordance with yet another embodiment the PDP type can be modified “on the fly”, when there is a need to transfer traffic that differs from the traffic type for which the PDP context is determined. For instance, on the basis of the DNS responses it is found that a different PDP type is needed, whereby the PDP context is modified with a PDP context modification message to match the necessary PDP type.

In accordance with an embodiment differing from the one described above, an IPv4 address added in addition to an IPv6 address to the PDP context is not part of the IPv6 address. And in signalling associated with PDP contexts, separate information elements are reserved for IPv4 and IPv6 addresses for the new PDP context type, and both PDP types would thus be simultaneously in use for one PDP context. According to another embodiment an IPv6 address is allocated to a conventional IPv6-type PDP context, but on the basis of a predetermined mechanism, MS and GGSN are arranged to deduce the IPv4 address from this IPv6 address. The deduced IPv4 address is also included in the PDP context and it can be used in the above-illustrated manner for IPv4 traffic. The IPv4 address deduction mechanism is unambiguous. Alternatively, the IPv6 address is deduced from the IPv4 address.

Various IPv4/IPv6 transition mechanism solutions describe embedding an IPv4 address in an IPv6 address, and one example of those is the Internet Draft publication “Intra-Site Automatic Tunnel Addressing Protocol (ISATAP)”, F. Templin, T. Gleeson, M. Talwar and D. Thaler, 15 Oct. 2003, 18 pages, at http://www.ietf.org/internet-drafts/draft-ietf-nqtrans-isatap-16.txt. It should be noted, however, that these transition solutions concern arrangement of tunnelling by using an embedded IPv4 address such that the IPv6 traffic can be transmitted over an IPv4 network. The IPv6 packets are thus transferred in IPv4 packet payload. The present solution does not concern tunnelling of this type, however, but transferring traffic of different address types in a wireless telecommunications network. Still, IPv4/IPv6 transition solutions can also be applied to a system comprising a wireless telecommunications network of this kind.

It is apparent to a person skilled in the art that as technology advances the basic idea of the invention can be implemented in a variety of ways. The invention and its embodiments are thus not restricted to the above-described examples but they may vary within the scope of the claims. Various features can thus be omitted, modified, combined or replaced by equivalents.

1. A method for arranging packet-switched data transmission in a wireless system, which method comprises:
activating a packet-data transmission context between a mobile station and a network element providing wireless packet-switched data transmission, a first address being included in said transmission context, wherein the transmission context is provided with a second address, in addition to the first address, and
transferring packets, whose IP address field comprises the second 10 address or the first address, by using the established transmission context.

2. A method as claimed in claim 1, wherein the second address is part of the first address, and
the packets, whose IP address comprises the second address or only the first address are transmitted by using the established transmission context.

3. A method as claimed in claim 1, wherein the first address is in the IPv6 address format and the second address is in the IPv4 address format.

4. A method as claimed in claim 1, wherein the received downlink packets are checked for a destination IP address field in the network element and the uplink packets are checked for a source IP address field in the mobile station.

5. A method as claimed in claim 1, wherein the system supports the GPRS standard and the transmission context is a PDP context.

6. A method as claimed in claim 5, wherein the first address and the second address are determined in a GGSN node of the system in response to a need to activate a PDP context for a wireless mobile station,
the first address and the second address are stored in PDP context information,
the first address and the second address are transmitted to the mobile station,
the first address and the second address are stored in the PDP context data, and
the mobile station is arranged to transmit the packets with the second address or the first address as the source address by using the PDP context.

7. A method as claimed in claim 1, wherein the first address also comprises an information field and
information relating to the transmission context is conveyed in the information field.

8. A wireless data communications system comprising at least one mobile station and a network element providing wireless packet-switched data transmission, in which
the network element and the mobile station are configured to activate a packet data transmission context, which includes a first address,
the network element and the mobile station are configured to provide the transmission context with a second address, in addition to the first address, and
the network element and the mobile station are configured to transfer the packets, whose IP address field comprises the second address or the first address, by using the established transmission context.

9. A mobile station comprising a transceiver for arranging wireless packet-switched data transmission, wherein
the mobile station is configured to activate the packet data transmission context with the network element providing wireless packet-switched data transmission,
the mobile station is configured to provide the transmission context with a second address, in addition to the first address, and
the mobile station is configured to transmit the packets, whose source IP address is or is determined to be the second address or the first address, by using the established transmission context.

10. A mobile station as claimed in claim 9, wherein the second address is part of the first address, and
the mobile station is configured to transmit the packets, whose IP address field comprises the second address or only the first address, by using the established transmission context.

11. A mobile station as claimed in claim 10, wherein the mobile station is configured to determine the second address from the first address received from the network element.

12. A mobile station as claimed in claim 9, wherein the first address is in the IPv6 address format and the second address is in the IPv4 format.

13. A mobile station as claimed in claim 9, wherein the mobile station is configured to support the GPRS standard and the transmission context is a PDP context.

14. A mobile station as claimed in claim 13, wherein the mobile station is configured to store the first address received from the GGSN node and the second address in the data of the activated PDP context, and
the mobile station is configured to transmit the packets with the second address or the first address as the source address by using said PDP context.

15. A mobile station as claimed in claim 9, wherein the mobile station is configured to determine the content of an information field comprised by the received first address, and
the mobile station is configured to use said content for the transmission context.

16. A network element for a network providing wireless packet-switched data transmission, in which
the network element is configured to activate a packet data transmission context for a mobile station,
the network element is configured to provide the transmission context with a second address, in addition to the first address, and
the network element is configured to transmit the packets whose destination IP address field comprises the second address or the first address, by using the established transmission context.

17. A network element as claimed in claim 16, wherein the second address is part of the first address, and
the network element is configured to transmit the packets, whose IP address field comprises the second address or only the first address, by using the established transmission context.

18. A network element as claimed in claim 16, wherein the first address is in the IPv6 address format and the second address is in the IPv4 address format.

19. A network element as claimed in claim 16, wherein the network element is configured to serve as a GGSN node according to the GPRS standard, and the transmission context is a PDP context.

20. A network element as claimed in claim 19, wherein the network element is configured to determine the first address and the second address in response to a need to activate a PDP context for a mobile station,
the network element is configured to store the first address and the second address in the PDP context information, and
the network element is configured to transmit the first address and the second address to the mobile station.

21. A network element as claimed in claim 16, wherein the network element is configured to determine in the first address an information field comprising information on the use of the transmission context.
